(19) United States
(12) Patent Application Publication
(10) Pub. No.: US 2026/0302879 A1
(43) Pub. Date: Oct. 1, 2026

(54) MOTOR UNIT AND A WHEELED VEHICLE AND A MACHINE TOOL EQUIPPED WITH SUCH A MOTOR UNIT

(71) Applicant: FRANCE REDUCTEURS, LES HERBIERS (FR)

(72) Inventor: Rémi ROUSSELOT, LES HERBIERS (FR)

(21) Appl. No.: 19/480,863

(22) PCT Filed: May 3, 2024
(86) PCT No.: PCT/FR2024/050580

§ 371 Date: Nov. 3, 2025

(30) Foreign Application Priority Data
May 9, 2023 (FR) FR2304590

(51) Int. Cl. H02K 7/00; A01D 34/64; A01D 34/78; A01D 101/00; H02K 7/06; H02K 7/08; H02K 7/10; H02K 7/14

(52) U.S. Cl. CPC H02K 7/003; A01D 34/64; A01D 34/78; H02K 7/06; H02K 7/083; H02K 7/10; H02K 7/14; A01D 2101/00; H02K 2213/09

(57) ABSTRACT

A motor unit is provided (1) having an electric motor (2) and a support (3). The motor (2) has a tool-holder shaft (4) with a rotor (7) for rotating the shaft (4), a stator (8) and a frame (9). The motor unit (1) has selectively activatable first and second configurations and an activation device (10) for the passage from one configuration to another. The motor (2) and the support (3) are, independently of a rotational movement of the rotor (7), mounted so as to be fixed axially in the first configuration. The tool-holder shaft (4), at its end (6) opposite its tool-holder end (5), partially projects from the frame (9) and has, at its projecting portion, a screw thread (11). The tool-holder shaft (4) is mounted so as to be fixed axially with respect to the rotor (7) and to the stator (8). In the second configuration, the motor (2) and the support (3) are, depending on the rotational movement of the rotor (7), mounted so as to be movable axially relative to one another in a direction parallel to the shaft (4) in order to vary the position of the tool-holder end (5) of the shaft (4) relative to the support (3). Each axial relative position between the tool-holder end (5) of the shaft (4) and the support (3) are a stable position.

The present invention relates to a motor unit and a wheeled vehicle and a machine tool equipped with such a motor unit.

It particularly relates to a motor unit comprising an electric motor and a support, said motor comprising a shaft referred to as a tool-holder shaft having a tool-holder end, a rotor for rotating said shaft, a stator, and a frame surrounding the stator and the rotor, said motor unit having first and second configurations that can be activated selectively, and an activation device for switching from one configuration to another, the motor and the support being mounted axially fixed along a direction parallel to the shaft in the first configuration, independently of a rotating movement of the rotor.

A device for rotating a tool-holder drive shaft having two configurations and making it possible for said shaft to be axially fixed relative to a support in a first configuration is known, as illustrated by WO 2022/069841. In the second configuration, the shaft and the stator are mounted so that they can move axially relative to each other as a function of the rotating movement of the rotor. Such a device has the advantage of being able to generate an axial movement of the shaft under the effect of the rotation of the rotor in the second configuration, this rotor also making it possible to rotate the shaft conventionally without axial movement in the first configuration. This results in a simplicity compared to devices that require two motors, one for rotating the shaft and one for moving the shaft axially. However, the solution as described in patent application WO 2022/069841 is not perfect in terms of mechanical strength. In particular, according to the design applied, the tool-holder shaft can protrude significantly relative to the roller bearing members that hold it. In addition, this shaft must sometimes be made in several parts, which results in a lack of precision in the adjustments and a further risk of breakage.

One aim of the invention is to propose a motor unit the design of which makes it possible to overcome the drawbacks of the prior art.

To this end, the invention relates to a motor unit comprising an electric motor and a support, said motor comprising a shaft referred to as a tool-holder shaft with a tool-holder end, a rotor for rotating said shaft, a stator, and a frame surrounding the stator and the rotor, said motor unit having first and second configurations that can be activated selectively, and an activation device for switching from one configuration to another, the motor and the support being mounted axially fixed along a direction parallel to the shaft in the first configuration, independently of a rotating movement of the rotor, characterized in that the tool-holder shaft is mounted axially fixed relative to the rotor and the stator, in that the tool-holder shaft partially protrudes from the frame at its end opposite the tool-holder end, and has, on its protruding portion, an external thread, and in that in the second configuration, the motor and the support are mounted so that they can move axially relative to each other in a direction parallel to the shaft as a function of the rotating movement of the rotor, in order to change the position of the tool-holder end of the shaft relative to the support, each relative axial position of the tool-holder end of the shaft and the support being a stable position. It should be noted that, within the meaning of the invention, stable position is given to mean a position that can be maintained after the motor has stopped when the motor unit is in a non-powered state. Conversely, an unstable position is a position that cannot be maintained when the motor unit is in a non-powered state. In the second configuration, the rotation of the rotor makes it possible for the motor and the support to move axially relative to each other, the direction of the relative axial movement being a function of the direction of rotation of the rotor. The rotation of the rotor in a first direction of rotation thus causes a relative axial movement of the motor and the support in a first direction, while the rotation of the rotor in a second direction of rotation causes a relative axial movement of the motor and the support in a second direction opposite to the first direction. In the first configuration, conversely, the motor and the support are arranged axially fixed relative to each other independently of a rotating movement of the rotor, that is, in the rotated state of the rotor and in the non-rotated state of the rotor. The rotor is thus a versatile rotor that, in addition to its role of rotating the shaft, can control a relative axial movement of the motor, and consequently of the shaft, relative to the support. The direction of rotation, operating time and angular range of movement of the rotor therefore control the relative axial movement of the motor and the support in the second configuration. The above results in a simplicity of the motor unit, since the rotor forms the controlling drive element in all configurations without the need for an additional drive element. It is thus possible, for example in the event of the application of such a motor unit to a mower, to control the adjustment of the cutting height and the rotation of the cutting blade using a single rotor without detracting from the mechanical strength of the motor unit. This is because, independently of the configuration of the motor unit, the tool-holder shaft remains axially fixed relative to the rotor. In the second configuration, the motor and the support are thus mounted so that they can move axially as a function of the rotating movement of the rotor in order to change the position of the tool-holder end of the shaft relative to the support in a direction closer to or more distant from the support, without changing the position of said tool-holder end of the shaft relative to the rotor or the stator.

According to one embodiment of the invention, the activation device comprises at least one internally threaded first part at least partially housed inside the support, the internal thread of this first part being permanently engaged with the external thread of the shaft. In the rotated state of the shaft and the rotatably immobilized state of the first part, this design allows an axial movement of the shaft by interaction between the external thread of the shaft and the internal thread of the rotatably immobilized first part.

According to one embodiment of the invention, the activation device comprises at least a second part constrained to rotate with the shaft and mounted so that it can move axially on the shaft between a position distant from and a position close to the first part, wherein the rotating movement of the second part can be transmitted to the first part by contact between said first and second parts, and an actuator having two positions, one of which is referred to as the first position and corresponds to the first configuration and the other of which is referred to as the second position and corresponds to the second configuration of the motor unit, wherein in its second position corresponding to the second configuration, said actuator acts on both the first and second parts so as to simultaneously rotatably immobilize the first part and keep the second part in its position distant from the first part. The first position of the actuator, which corresponds to the first configuration of the motor unit, is a position in which the second part is in its position close to the first part in order to transmit its rotating movement to the first part, and the first part is free to rotate with the shaft that holds it.

According to one embodiment of the invention, the motor unit comprises an intermediate element of the actuator interposed between the actuator and the second part, and, in its second position corresponding to the second configuration, the actuator acts on the second part by means of said intermediate element, which takes the form of a pivoting lever.

According to one embodiment of the invention, the second part is equipped with a member for returning it to its position close to the first part, and the actuator is equipped with an element for returning the actuator to the first position corresponding to the first configuration of the motor unit, in which the second part is in its position close to the first part in order to transmit its rotating movement to the first part, and the first part is free to rotate with the shaft that holds it.

According to one embodiment of the invention, in its state at least partially housed inside the support, the first part is arranged at least partially between the second part and a roller bearing member housed inside the support so that the first part is sandwiched between the second part and the roller bearing member in the position in which the second part is close to the first part, such that any axial movement of the first part is prevented. This arrangement makes it possible to avoid any axial movement of the first part at least in the first configuration of the motor unit.

According to one embodiment of the invention, the first part and the second part are respectively provided with dog elements for dog clutch coupling in the close position of the first and second parts. This dog clutch coupling allows the simple, safe transmission of the rotating movement of the second part, constrained to rotate with the tool-holder shaft, to the first part.

According to one embodiment of the invention, the first part comprises, preferably integrally formed, a nut, a flange extending in the axial continuation of the nut, and radial arms arranged around the flange/nut assembly.

According to one embodiment of the invention, the dog elements of the first part are arranged on the inside of the flange.

According to one embodiment of the invention, the second part at least takes the form of a cylindrical body provided at each of its ends with a plate that is pierced centrally so that it can be threaded onto the shaft, the plate closest to the first part being provided with the dog elements of said second part.

According to one embodiment of the invention, the actuator is formed by the movable part of an electromagnetic system, such as a solenoid, one of the first and second positions of the actuator corresponding to the position occupied by the movable part in the non-powered state of the electromagnetic system, the other corresponding to the position occupied by the movable part in the powered state of the electromagnetic system.

According to one embodiment of the invention, the support is a hollow body, the motor and the support are mounted so that one slides inside the other with an overlap zone and, in the second configuration, the motor and the support are mounted so that one slides axially inside the other in a direction parallel to the shaft as a function of the rotating movement of the rotor, in the direction of an increase or a reduction in the overlap zone, in order to change the position of the tool-holder end of the shaft relative to the support.

According to one embodiment of the invention, the frame of the motor is equipped with guide members for relative sliding with the support, said guide members being integrally formed with the frame and taking the form of rails capable of interacting with channels made in the support. Again, this structure results in a simplicity of the motor unit without detracting from its mechanical strength.

According to one embodiment of the invention, the unit comprises at least one sensor for sensing the limit of the relative axial movement of the motor and the support, with one portion fixedly mounted on the motor and one portion rigidly connected to the support, said portions interfering with each other in the closest position of the tool-holder end of the shaft to the support.

According to one embodiment of the invention, the tool-holder shaft surrounded by the rotor and the stator is equipped with at least one roller bearing member for keeping the shaft inside the frame of the motor, and the distance between the roller bearing member or members and the tool-holder end of the tool-holder shaft is kept constant regardless of the configuration of the motor unit. The distance between the roller bearing member or members and the tool-holder end of the tool-holder shaft is therefore kept constant in the first and second configurations of the motor unit.

According to one embodiment of the invention, the tool that can be held by the tool-holder shaft is a cutting blade.

The invention further relates to a wheeled vehicle, preferably for mowing, comprising a motor unit, characterized in that the motor unit is of the aforementioned type.

The invention further relates to a machine tool comprising a motor unit, characterized in that the motor unit is of the aforementioned type.

### BRIEF DESCRIPTION OF THE DRAWINGS

The invention will be clearly understood on reading the following description of embodiments, with reference to the appended drawings, in which:

FIG. 1 shows a perspective view of a wheeled vehicle, particularly a robotic mower, equipped with a motor unit according to the invention;

FIG. 2 shows, in two cross-sectional views of the motor unit and two partial perspective views each associated with a cross-sectional view, the switching of the actuator of the activation device from a first position corresponding to the first configuration of the motor unit to a second position corresponding to the second configuration of the motor unit;

FIG. 3 shows, in two cross-sectional views of the motor unit and two detailed views each associated with a cross-sectional view, the axial movement of the motor relative to the support for switching from a distant position of the tool-holder end of the shaft relative to the support to a close position of the tool-holder end of the shaft relative to the support;

FIG. 4 shows a partial perspective view, with the elements in an exploded position, of the tool-holder shaft and the associated activation device;

FIG. 5 shows, in two front views, the motor unit during the switch from a distant position of the tool-holder end of the shaft relative to the support to a close position of the tool-holder end of the shaft relative to the support;

FIG. 6 shows a perspective view of the support and the frame ready to be assembled by sliding one inside the other;

FIG. 7 shows a perspective view of the support and the frame when assembled by sliding one inside the other;

FIG. 8 shows a perspective view of the first part seen from the inside of said first part;

FIG. 9 shows a perspective view of a machine tool equipped with a motor unit according to the invention.

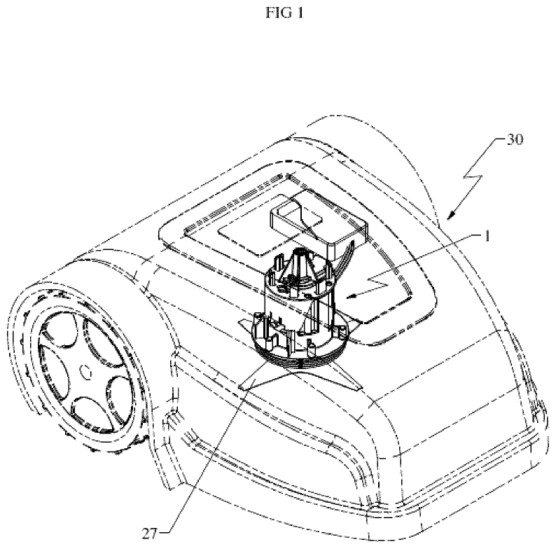

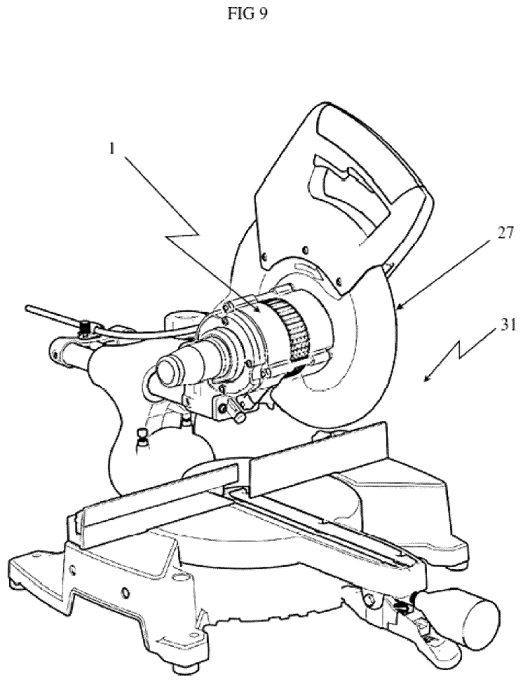

As mentioned above, the invention relates to a motor unit 1 suitable for being installed, for example, on a wheeled vehicle 30, as illustrated in FIG. 1, which shows a robotic mower, or on a machine tool 31, as illustrated in FIG. 9.

Such a motor unit 1 comprises an electric motor 2 and a support 3. The motor 2 comprises a shaft 4 referred to as a tool-holder shaft 4. This shaft 4 is suitable for being equipped at one end, referred to as the tool-holder end 5, with a work tool. This work tool can be a cutting tool or a piercing or other tool. FIGS. 1 to 9 illustrate a work tool in the form of a rotary cutting blade.

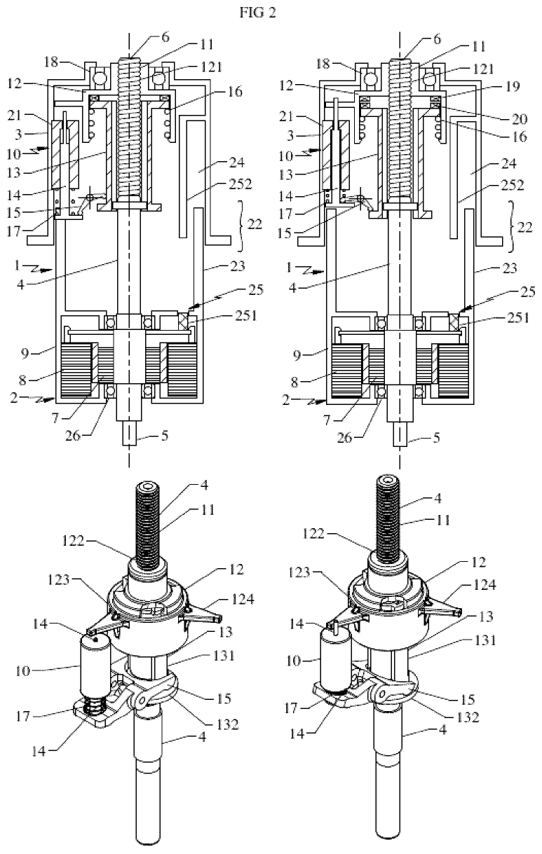

The electric motor 2 further comprises a stator 8 and a rotor 7 for rotating the shaft 4 in two directions of rotation. The rotor 7 is pierced centrally in order to define a through-passage for the shaft 4, which forms the drive shaft of the electric motor 2. The rotor 7 is generally formed by a stack of laminations and by magnets arranged close to the periphery of the rotor so that they are attracted by a rotating magnetic field generated at the stator 8. The stator 8 is formed by laminations interacting with a winding in order to form an electromagnetic portion. A frame 9 at least partially surrounds the electromagnetic portion of the stator 8 and the rotor 7 in a manner known per se. The enclosure of this frame 9 has at least one through-hole from which the shaft 4 protrudes. This frame 9, which surrounds the rotor 7, the stator 8, and at least part of the shaft 4, can also define one or more cavities housing components, such as roller bearing members denoted 26 in FIG. 2. The or each roller bearing member 26 surrounds the shaft 4 and holds the shaft 4 inside the frame 9.

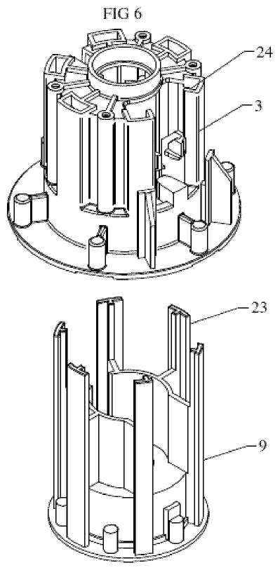

The rotor 7 is a rotor having two directions of rotation, capable of rotating in a clockwise direction and an anti-clockwise direction. The electric motor 2, comprising the stator 8 and the rotor 7, can be a direct current motor or an alternating current motor. This motor can be brushless. The support 3, which can be seen more particularly in FIG. 6, is a hollow body suitable for being fastened so that it is stationary on the wheeled vehicle 30 or the machine tool 31 that it equips. Generally, this support 3 is made from a synthetic material. Here, it is in the general shape of a bell provided with an outer circumferential collar and a central cavity inside which the end 6 of the shaft opposite the tool-holder end 5 of the shaft 4 can be housed. The collar assists with fastening the support 3. The motor 2 and the support 3 are mounted so that one slides inside the other with an overlap zone 22 that corresponds to the zone in which the motor 2 and the support 3 overlap.

So that they can be mounted such that one slides inside the other, the frame 9 of the motor 2, which is made from a synthetic material, is equipped with guide members 23. These guide members 23, which are integrally formed with the frame 9, take the form of rails capable of interacting with channels 24 made in the support 3.

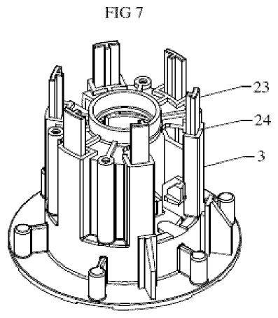

In the example shown in FIG. 6, the frame 9 takes the form of a sleeve that is externally provided with a collar from which extend a plurality of fingers arranged parallel to the longitudinal axis of the sleeve. These fingers each form a rail forming a guide member 23 of the frame 9. Mounting takes place simply by inserting the guide members 23 of the frame 9 into the channels 24 of the support 3, as illustrated in FIG. 7. These channels 24 are in the form of longitudinal slots made in the body forming the support 3.

It will be noted that the part of the shaft 4 that extends at least partially inside the support 3 is an externally threaded portion over at least part of the length of the shaft 4. This external thread is denoted 11 in FIG. 2. This external thread is therefore arranged on the part of the shaft 4 that protrudes from the frame 9 towards the support 3 when the support 3 and the motor 2 are mounted so that one slides inside the other. This part of the shaft 4 that protrudes from the frame 9 has a driving end in the form of the end of the shaft 4 opposite the tool-holder end 5 of the shaft 4. In other words, the external thread 11 is arranged on at least one portion of the part of the shaft 4 that protrudes from the frame 9 and extends between the end of the shaft 4 opposite the tool-holder end 5 of the shaft 4 and the frame 9.

As illustrated in the figures, the tool-holder shaft 4 is fixedly mounted axially, that is, in a direction parallel to the longitudinal axis of the shaft 4 relative to the rotor 7 and the stator 8. As a result, the distance between the roller bearing member or members 26 and the tool-holder end 5 of the tool-holder shaft 4 is therefore kept constant regardless of the configuration of the motor unit 1. This arrangement makes it possible for the shaft 4 to have suitable mechanical strength at its tool-holder end 5.

The motor unit 1 has a first configuration and a second configuration. These first and second configurations can be activated selectively and the motor unit 1 comprises an activation device 10 for switching from one configuration to another.

In the first configuration according to the left-hand views in FIG. 2, the motor 2 and the support 3 are mounted axially fixed relative to each other, in a direction parallel to the shaft 4, particularly to its longitudinal axis, independently of a rotating movement of the rotor 7. In other words, whether or not the rotor 7 and consequently the shaft 4 is rotating and regardless of their direction of rotation, the motor 2 and the support 3 remain axially fixed relative to each other in this first configuration.

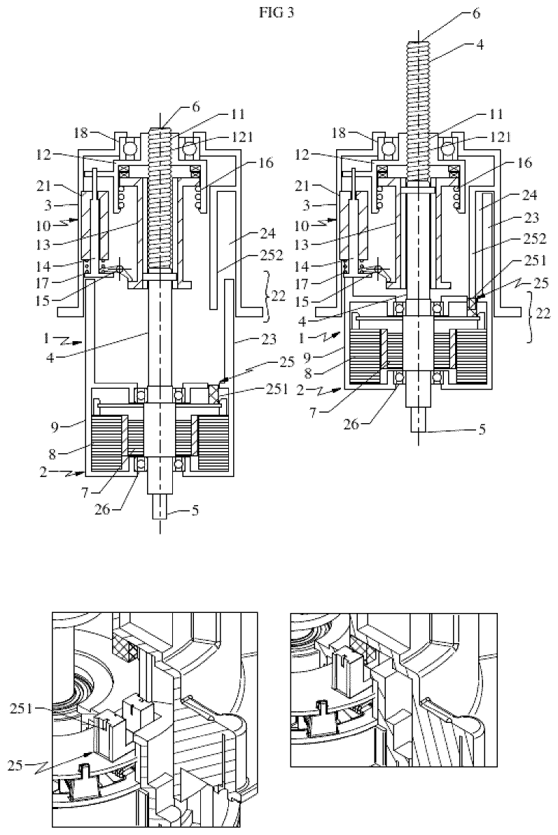

Conversely, in the second configuration, as illustrated in the right-hand views in FIG. 2 or the views in FIG. 3, the motor 2 and the support 3 are mounted so that they can move axially relative to each other in a direction parallel to the shaft 4 as a function of the rotating movement of the rotor 7, in order to change the position of the tool-holder end 5 of the shaft 4 relative to the support 3. Each relative axial position of the tool-holder end 5 of the shaft 4 and the support 3 is a stable position. In this second configuration, the motor 2 and the support 3 are thus mounted so that one slides axially inside the other in a direction parallel to the shaft 4 as a function of the rotating movement of the rotor 7, in the direction of an increase or a reduction in the overlap zone 22, in order to vary the position of the tool-holder end 5 of the shaft 4 relative to the support 3. This variation of the relative axial position of the tool-holder end 5 of the shaft 4 and the support 3 makes it possible, in the case of an application according to the robotic mower in FIG. 1, to change the cutting height or, in the case of the machine tool in FIG. 9, to change the cutting position.

In order to make it possible to switch from one configuration to another, the motor unit 1 comprises an activation device 10, more particularly visible in FIGS. 2 to 4. This activation device 10 comprises at least one internally threaded first part 12 at least partially housed inside the support 3, the internal thread 121 of this first part 12 being permanently engaged with the external thread 11 of the shaft 4.

This activation device 10 comprises a second part 13 constrained to rotate with the shaft 4 and mounted on the shaft 4 so that it can move axially between a position distant from and a position close to the first part 12, wherein the rotating movement of the second part 13 can be transmitted to the first part 12 by contact between said first and second parts 12 and 13.

The activation device 10 further comprises an actuator 14 having two positions, one of which is referred to as the first position and corresponds to the first configuration of the motor unit 1 and the other of which is referred to as the second position and corresponds to the second configuration of the motor unit 1. In its second position corresponding to the second configuration, this actuator 14 acts on both the first and second parts 12 and 13 in order to simultaneously rotatably immobilize the first part 12 and hold the second part 13 in its position distant from the first part 12.

The actuator is formed by the movable part of an electromagnetic system 21. Here, this electromagnetic system 21 is a solenoid with a winding around a core made from a ferromagnetic material. This core, which forms the movable part of the electromagnetic system 21, takes the form here of a spring-loaded rod, the spring forming an element 17 for returning the actuator 14. The core, which forms the actuator 14, is mounted so that it can slide inside the winding when the winding is powered, against the action of the return element 17. The actuator 14 is therefore capable of occupying two separate positions as a function of the powered or non-powered state of the electromagnetic system 21.

The first position of the actuator 14, occupied by the actuator 14 in the non-powered state of the electromagnetic system 21, is shown in the left-hand views in FIG. 2, and corresponds to the first configuration of the motor unit.

The second position of the actuator 14, occupied by the actuator 14 in the powered state of the electromagnetic system 21, is shown in the right-hand views in FIG. 2 or in FIG. 3, and corresponds to the second configuration of the motor unit 1.

The return element 17, which returns the actuator 14 to the first position, is a helical spring surrounding the actuator 14 and arranged between a shoulder of the actuator 14 and the winding of the electromagnetic system 21.

In the first configuration of the motor unit, which corresponds to a situation in which the actuator 14 is in the first position, the second part 13 is in its position close to the first part 12 in order to transmit its rotating movement to the first part 12, and the first part 12 is free to rotate with the shaft 4 that holds it, as illustrated in the left-hand views in FIG. 2.

In order to allow this transmission of the rotating movement of the second part 13, which is constrained to rotate with the shaft 4, to the first part 12, the first part 12 and the second part 13 are respectively provided with dog elements for dog clutch coupling in the close position of the first and second parts. The dog elements of the first part 12 are denoted 19 in the figures, while the dog elements of the second part 13 are denoted 20 in the figures.

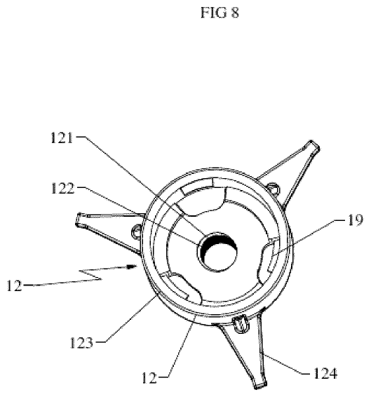

A detail of the first part 12 is shown in FIG. 8. In this example, the first part 12 comprises, integrally formed, a nut 122, a flange 123 extending in the axial continuation of the nut 122, and radial arms 124 arranged around the flange 123/nut 122 assembly. These dog elements 19 of the first part 12 are arranged on the inside of the flange 123.

These dog elements 19 are formed by an inner peripheral crenelation of the flange. In its state at least partially housed inside the support 3, the first part 12 is arranged at least partially between the second part 13 and a roller bearing member 18 housed inside the support 3 so that the first part 12 is sandwiched between the second part 13 and the roller bearing member 18 in the position in which the second part 13 is close to the first part 12, such that any axial movement of the first part 12 is prevented in the position in which the second part is close to the first part 12.

The second part 13 is equipped with a member 16 for returning it to its position close to the first part 12. This return member 16 takes the form of an elastically deformable member, such as a spring, interposed between the first and second parts. In the example in FIGS. 2 and 3, this return member 16 is housed inside the flange of the first part between the free end of the flange and a shoulder of the second part 13 inserted at least partially into the flange 123.

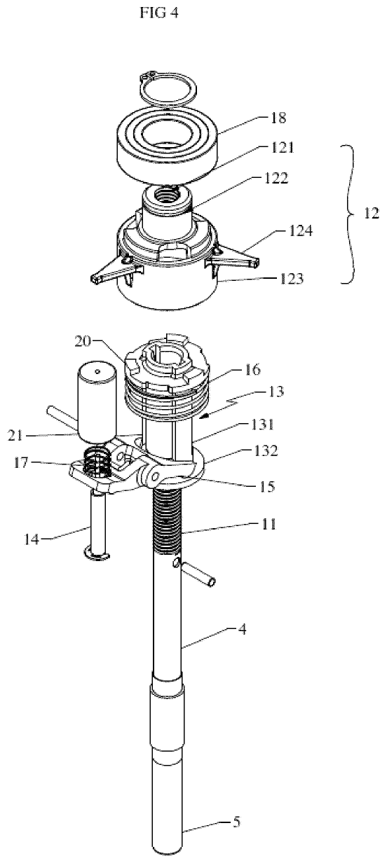

The second part 13 at least takes the form of a cylindrical body 131 provided at each end with a plate 132 that is pierced centrally so that it can be threaded onto the shaft 4. The plate 132 of the second part 13 closest to the first part 12 is provided with the dog elements 20 of the second part 13. These dog elements 20 are particularly visible in FIG. 4. These dog elements are formed by a crenelation made on the outer face of the plate 132 intended to be inserted into the flange 123 of the first part 12. In the position in which the first and second parts are close to each other, the protrusions of the crenelation of the second part 13 are thus inserted into the space left free between two protrusions of the crenelation of the first part 12, so that in the rotated state of the second part 13, the first part 12 rotates with the second part 13.

In order to be constrained to rotate with the shaft 4 and free to move axially on the shaft 4, the second part 13 is connected to the shaft 4 by a pin. This pin, visible in FIG. 4, passes through the shaft 4 and is inserted into two longitudinal slots or apertures in the second part 13. As it switches from the first to the second position, under the effect of the powering of the electromagnetic system, the actuator 14 is configured to act on an intermediate element 15 of the actuator 14. Here, this intermediate element 15 takes the form of a pivoting lever visible in FIG. 4. As it pivots, this pivoting lever in turn acts on the second part 13 against the action of the member 16 for returning the second part 13 to its position close to the first part 12. This pivoting lever thus makes it possible for the second part 13 to switch from its position close to the first part 12 to its position distant from the first part by bearing on one of the plates 132 of the second part 13.

Simultaneously with its action on the intermediate element 15, the actuator 14 is also configured, as it switches from the first position to the second position, to act on the first part 12 in order to rotatably immobilize the first part 12. To this end, in the second position of the actuator 14, the end of the rod forming the actuator 14 is configured to be positioned between the radial arms 124 of the first part 12, so that the first part 12 can no longer rotate, as illustrated in the right-hand views in FIG. 2.

In its second position, corresponding to the second configuration of the motor unit 1, the actuator 14 therefore acts both on the first part 12, which it rotatably immobilizes, and on the second part 13 by means of the intermediate element 15, in order to hold the second part 13 in its position distant from the first part 12 so that the dog elements 19 and 20 are in the disengaged state and the second part 13 no longer transmits its rotating movement to the first part 12.

It will be understood that, in this second configuration, by interaction between the external thread 11 of the shaft 4 and the internal thread 121 of the rotatably immobilized first part 12, the rotation of the shaft 4 drives an axial movement of the shaft 4 and, consequently, of the rotor 7 and the stator 8 of the motor, relative to which the shaft 4 is axially fixedly mounted.

The axial movement of the shaft 4 takes place in a direction that is a function of the direction of rotation of the shaft 4, so that the overlap zone 22 can change in the direction of an increase, as illustrated in FIG. 3, during the switch from the left-hand views to the right-hand views in FIG. 3, or in the direction of a reduction of the overlap zone 22 when the direction of rotation of the shaft 4 is reversed.

Finally, to complete the motor unit 1, said motor unit 1 comprises at least one sensor 25 for sensing the limit of the relative axial movement of the motor 2 and the support 3, with one portion 251 fixedly mounted on the motor 2 and one portion 252 rigidly connected to the support 3. The portions 251 and 252 interfere with each other in the closest position of the tool-holder end 5 of the shaft 4 to the support 3.

In the example shown in FIG. 3, the portion 251 fixedly mounted on the motor is U-shaped, with a ray, for example a light ray, extending between the branches of the U. The portion 252, rigidly connected to the support 3, is formed by a rod that intersects the ray from the portion 251 mounted on the motor 2 in the position in which the support and the motor have the largest overlap zone 22, as illustrated in the right-hand view in FIG. 3. This intersecting of the ray makes it possible to detect a limit position of the insertion of the motor 2 into the support 3. A signal can be sent to the control unit of the motor unit 1. This control unit takes the form of an electronic computer system that comprises for example a microprocessor and a working memory. According to one particular aspect, the control unit can take the form of a programmable logic controller.

In other words, the functions and steps described can be implemented in the form of a computer program or via hardware components (for example field-programmable gate arrays). In particular, the functions and steps performed by the control unit or the modules thereof can be carried out by sets of instructions or computer modules implemented in a processor or controller, or carried out by dedicated electronic components or FPGA or ASIC components. It is also possible to combine computing parts and electronic parts.

When it is stated that the unit or means or modules of said unit are configured to perform a given operation, this means that the unit comprises computing instructions and corresponding execution means that make it possible to perform said operation, and/or that the unit comprises corresponding electronic components.

This control unit can control the angular position of the rotor, the rotation time of the rotor, the speed of rotation and the direction of rotation of the rotor. In the second configuration, these elements influence the relative axial travel between the support 3 and the motor 2. The user can enter the desired axial travel into the control unit, for example via a human-machine interface, or it can be pre-saved. The value of the thread pitch of the shaft can also be saved in order to govern the axial travel.

In practice, the operation of the motor unit 1 as described above is as follows. It is assumed that the actuator 14 of the activation device 10 is in the first position corresponding to the non-powered state of the electromagnetic system 21, as illustrated in the left-hand views in FIG. 2. The motor unit 1 is therefore in the first configuration. In this first configuration, the motor 2 and the support 3 are mounted axially fixed relative to each other, including in the rotated state of the rotor 7 and, consequently, of the shaft 4. The actuator 14 is returned by the return element 17 to its position distant from the first part 12, which is thus free to rotate with the shaft 4. The second part 13 is returned by the return member 16 to its position close to the first part 12 and the dog elements 19 and 20 are in the engaged state, so that the rotating movement of the shaft 4 can be transmitted by the second part 13 to the first part 12. The first and second parts, together with the shaft 4, thus form a rotating assembly with the shaft 4, which rotates the work tool when it is present. When the electromagnetic system 21 is powered, the actuator 14 is moved to the second position, corresponding to the second configuration of the motor unit in which the motor 2 and the support 3 are mounted so that they can move axially relative to each other in a direction parallel to the shaft 4, in particular to its longitudinal axis, in order to change the position of the tool-holder end 5 of the shaft 4 relative to the support 3.

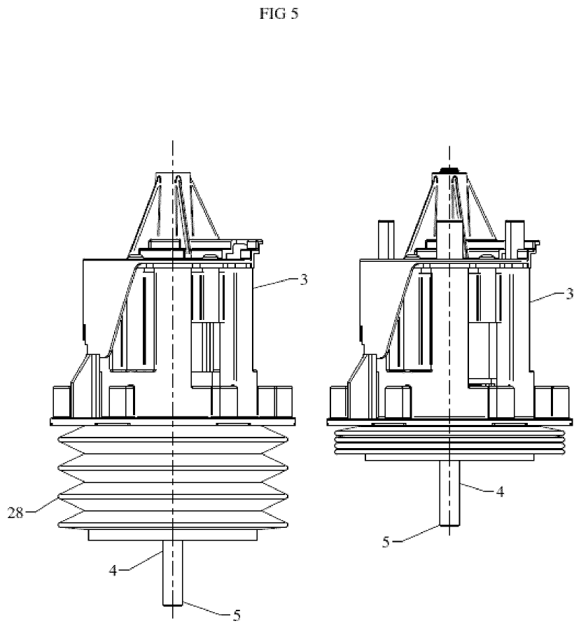

In this second position of the actuator 14, it acts via the intermediate element 15 on the second part 13 in order to keep it distant from the first part 12, and on the first part 12 in order to prevent it from being rotated, as illustrated in the right-hand views in FIG. 2. In this second position of the actuator 14, the rotating movement of the second part 13 is no longer transmitted to the first part 12 by the dog elements 19 and 20, and since the first part 12 is prevented from rotating, a rotating movement of the shaft 4 generates, by interaction between the external thread 11 of the shaft 4 and the internal thread 121 of the first part 12, a relative axial movement of the shaft 4/rotor 7/stator 8 assembly and the support 3, which results in a change in the dimension of the overlap zone 22, as illustrated in FIG. 3 and FIG. 5. It should be noted, as illustrated in FIG. 5, that the support 3 and the motor 2 can be linked to each other by a protective bellows 28 that protects at least one portion of the part of the motor 2 that protrudes from the support 3. When the electromagnetic system 21 is no longer powered, the actuator 14 of the activation device 10 returns to the first position under the effect of its return element 17 and releases any pressure on the second part 13 so that this second part 13 returns to the position in which the first and second parts are close to each other under the effect of its return member 16. The motor unit 1 is in the first configuration in which the rotation of the shaft 4 has no effect on the relative axial positions of the motor 2 and the support 3.

The operation of such a motor unit 1 is therefore extremely simple, and a single motor allows both the rotation of the shaft 4 and the associated work tool, and a relative axial movement of the support 3 and the motor 2 and, consequently, of the shaft 4, without detracting from the mechanical strength of the motor unit 1 in light of the protrusion of the tool-holder end 5 of the shaft 4 relative to the frame 9 and the roller bearing members 26 supporting the shaft 4 in the motor 2. The 4 shaft can be integrally formed. The length of the shaft 4 measured between the two ends of the shaft 4 remains unchanged on the switch from one configuration to another.

1. A motor unit comprising:
an electric motor and a support, said motor comprising a shaft referred to as a tool-holder shaft having a tool-holder end, a rotor for rotating said shaft, a stator, and a frame surrounding the stator and the rotor, said motor unit having first and second configurations that can be activated selectively, and an activation device for switching from one configuration to another, the motor and the support being mounted axially fixed in a direction parallel to the shaft in the first configuration, independently of a rotating movement of the rotor,
wherein the tool-holder shaft is mounted axially fixed relative to the rotor and the stator, in that the tool-holder shaft partially protrudes from the frame at its end opposite the tool-holder end, and has, on its protruding portion, an external thread, and in that in the second configuration, the motor and the support are mounted so that they can move axially relative to each other in a direction parallel to the shaft as a function of the rotating movement of the rotor, in order to change the position of the tool-holder end of the shaft relative to the support, each relative axial position of the tool-holder end of the shaft and the support being a stable position.

2. The motor unit as claimed in claim 1, wherein the activation device comprises at least one internally threaded first part at least partially housed inside the support, the internal thread of this first part (12) being permanently engaged with the external thread of the shaft.

3. The motor unit as claimed in claim 2, wherein the activation device comprises at least a second part constrained to rotate with the shaft and mounted so that it can move axially on the shaft between a position distant from and a position close to the first part, wherein the rotating movement of the second part can be transmitted to the first part by contact between said first and second parts, and an actuator having two positions, one of which is referred to as the first position and corresponds to the first configuration and the other of which is referred to as the second position and corresponds to the second configuration of the motor unit, wherein in its second position corresponding to the second configuration, the actuator acts on both the first and second parts so as to simultaneously rotatably immobilize the first part and keep the second part in its position distant from the first part.

4. The motor unit as claimed in claim 3, that wherein the motor unit comprises an intermediate element of the actuator interposed between the actuator and the second part, and in that, in its second position corresponding to the second configuration, the actuator acts on the second part by means of said intermediate element, which takes the form of a pivoting lever.

5. The motor unit as claimed in claim 3 4, wherein the second part is equipped with a member for returning it to its position close to the first part, and in that the actuator is equipped with an element for returning the actuator to the first position corresponding to the first configuration of the motor unit, in which the second part is in its position close to the first part in order to transmit its rotating movement to the first part, and the first part is free to rotate with the shaft that holds it.

6. The motor unit as claimed in claim 3, wherein in its state at least partially housed inside the support, the first part is arranged at least partially between the second part and a roller bearing member housed inside the support so that the first part is sandwiched between the second part and the roller bearing member in the position in which the second part is close to the first part, such that any axial movement of the first part is prevented.

7. The motor unit as claimed in claim 3, wherein the first part and the second part are respectively provided with dog elements for dog clutch coupling in the close position of the first and second parts.

8. The motor unit as claimed in claim 2, wherein the first part comprises a nut, a flange extending in the axial continuation of the nut, and radial arms arranged around the flange/nut assembly.

9. The motor unit as claimed in claim 8,
wherein the first part and the second part are respectively provided with dog elements for dog clutch coupling in the close position of the first and second parts; and
wherein the dog elements of the first part are arranged on the inside of the flange.

10. The motor unit as claimed in claim 7, wherein the second part at least takes the form of a cylindrical body provided at each of its ends with a plate that is pierced centrally so that it can be threaded onto the shaft, the plate closest to the first part being provided with the dog elements of said second part.

11. The motor unit as claimed in claim 3, wherein the actuator is formed by the movable part of an electromagnetic system, one of the first and second positions of the actuator corresponding to the position occupied by the movable part in the non-powered state of the electromagnetic system, the other corresponding to the position occupied by the movable part in the powered state of the electromagnetic system.

12. The motor unit as claimed in claim 1, wherein the support is a hollow body, in that the motor and the support are mounted so that one slides inside the other with an overlap zone and in that, in the second configuration, the motor and the support are mounted so that one slides axially inside the other in a direction parallel to the shaft as a function of the rotating movement of the rotor, in the direction of an increase or a reduction in the overlap zone, in order to change the position of the tool-holder end of the shaft relative to the support.

13. The motor unit as claimed in claim 1, wherein the frame of the motor is equipped with guide members for relative sliding with the support, said guide members being integrally formed with the frame and taking the form of rails capable of interacting with channels made in the support.

14. The motor unit as claimed in claim 1, wherein said motor unit comprises at least one sensor for sensing the limit of the relative axial movement of the motor and the support, with one portion fixedly mounted on the motor and one portion rigidly connected to the support, said portions interfering with each other in the closest position of the tool-holder end of the shaft to the support.

15. The motor unit as claimed in claim 1, wherein the tool-holder shaft surrounded by the rotor and the stator is equipped with at least one roller bearing member for keeping the shaft inside the frame of the motor, and in that the distance between the roller bearing member or members and the tool-holder end of the tool-holder shaft is kept constant regardless of the configuration of the motor unit.

16. The motor unit as claimed in claim 1, wherein the tool that can be held by the tool-holder shaft is a cutting blade.

17. A wheeled vehicle comprising: a motor unit, wherein the motor unit is as claimed in claim 1.

18. A machine tool comprising a motor unit, wherein the motor unit is as claimed in claim 1.

19. The wheeled vehicle as claimed in claim 17, wherein said wheel vehicle is a mower.
